(19) United States
(12) Patent Application Publication
(10) Pub. No.: US 2025/0117010 A1
(43) Pub. Date: Apr. 10, 2025

(54) METHOD FOR DETERMINING OPTIMAL MACHINE PERFORMANCE DURING AUTONOMOUS OPERATION

(71) Applicant: Caterpillar Inc., Peoria, IL (US)

(72) Inventors: Eric J. SCHULTZ, Metamora, IL (US); Philip WALLSTEDT, Washington, IL (US)

(73) Assignee: Caterpillar Inc., Peoria, IL (US)

(21) Appl. No.: 18/480,861

(22) Filed: Oct. 4, 2023

(51) Int. Cl. G05D 1/02

(52) U.S. Cl. CPC G05D 1/0214

(57) ABSTRACT

A method or system for managing autonomous vehicle operations includes receiving inputs including a task command for an autonomous mobile machine, determining an expected travel trajectory for the autonomous mobile machine to perform the task command, and determining an actual travel trajectory of the mobile machine during performance of the task command. The method or system further includes comparing the actual travel trajectory to the expected travel trajectory, and identifying an incident limiting factor responsible for a deviation between the actual travel trajectory and the expected travel, wherein comparing the actual travel trajectory is repeated at predetermined intervals during performance of the task command.

### TECHNICAL FIELD

The present disclosure relates generally to autonomous vehicle control, and, more particularly, to methods and systems for managing autonomous vehicle operations.

### BACKGROUND

Autonomous vehicles are used in mine sites for the loading, transport, and/or unloading of materials. For example, load-haul-dump machines (“LHDs”) may be operated autonomously to perform cycles of loading material at a first location, transporting the material to a second location, unloading the material at the second location, and returning to the first location to begin a new cycle. In such operation, the LHD is programmed to navigate the mine site based on known road geometry, speed restrictions, and the like. Productivity may be lost due to several factors, such as obstacles encountered in the path of the LHD, losses of traction, and delays due to interactions with other machines. Such productivity losses may be difficult to summarize and quantify as conventional techniques analyze the performance of the LHD at the end of each cycle through post-processing of data. As a result, the individual factors and/or incidents that contributed to productivity loss may not be readily identifiable, and therefore not readily addressable. Therefore, it would be advantageous to identify factors effecting efficiently of the machine in substantially real time.

U.S. Patent Application Publication No. 2021/0388577 to Eklund et al. (“the '577 publication”) describes a method for controlling an autonomous vehicle (e.g., a hauler) in a worksite by adding a variation to a predetermined trajectory, and determining whether the variation reduces energy usage of the vehicle. More specifically, the described method includes the steps of receiving a predetermined trajectory of a work sequence of the autonomous vehicle, adding a variation to the predetermined trajectory to form a test trajectory, comparing the energy usage over the test trajectory and the predetermined trajectory, determining whether or not the compared energy usage achieves a pre-set criteria, and setting the test trajectory as a new set trajectory of the autonomous vehicle in response to determining that the compared energy usage achieves the pre-set criteria.

While the '577 publication describes determining whether the variation reduces energy usage over the entire work cycle, the '577 publication does not disclose determining an event or obstacle encountered during the work sequence that causes a delay and/or excess energy usage.

The methods and systems of the present disclosure may address this deficiency of the '577 publication and/or address other problems in the art. The scope of the current disclosure, however, is defined by the attached claims, and not by the ability to solve any specific problem.

### SUMMARY

According to one aspect of this disclosure, a method for managing autonomous vehicle operations includes receiving inputs including a task command for an autonomous mobile machine, determining an expected travel trajectory for the autonomous mobile machine to perform the task command, and determining an actual travel trajectory of the mobile machine during performance of the task command. The method further includes comparing the actual travel trajectory to the expected travel trajectory, and identifying an incident limiting factor responsible for a deviation between the actual travel trajectory and the expected travel, wherein comparing the actual travel trajectory is repeated at predetermined intervals during performance of the task command.

According to another aspect of this disclosure, a system for managing autonomous vehicle operations includes an autonomous mobile machine configured to perform a task command comprising a loading operation, a transport operation, and an unloading operation, and a controller. The controller is configured to determine an actual travel trajectory of the mobile machine during performance of the task command; and repeatedly at a predetermined unit travel distance of the mobile machine, identify an incident limiting factor responsible for a deviation between the actual travel trajectory and the expected travel trajectory.

According to yet another aspect of this disclosure, a method for managing autonomous vehicle operations includes receiving inputs including a task command for an autonomous mobile machine, determining an expected travel trajectory for the autonomous mobile machine to perform the task command, and determining an actual travel trajectory of the mobile machine during performance of the task command. The method further includes comparing the actual travel trajectory to the expected travel trajectory, identifying an incident limiting factor responsible for a deviation between the actual travel trajectory and the expected travel, and adjusting the expected travel trajectory based on the incident limiting factor.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic view of a worksite including a plurality of mobile machines, according to aspects of the disclosure.

FIG. 2 is a block diagram of a control system of the mobile machine and/or back office of FIG. 1.

FIG. 3 is a flowchart depicting an exemplary method for managing autonomous vehicle operations.

FIG. 4 is a graph depicting actual travel speed versus expected travel speed of a mobile machine over time.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a method or apparatus that comprises a list of elements does not include only those elements, but may include other elements not expressly listed or inherent to such a method or apparatus. In this disclosure, relative terms, such as, for example, “about,” “substantially,” “generally,” and “approximately” are used to indicate a possible variation of ±10% in the stated value or characteristic.

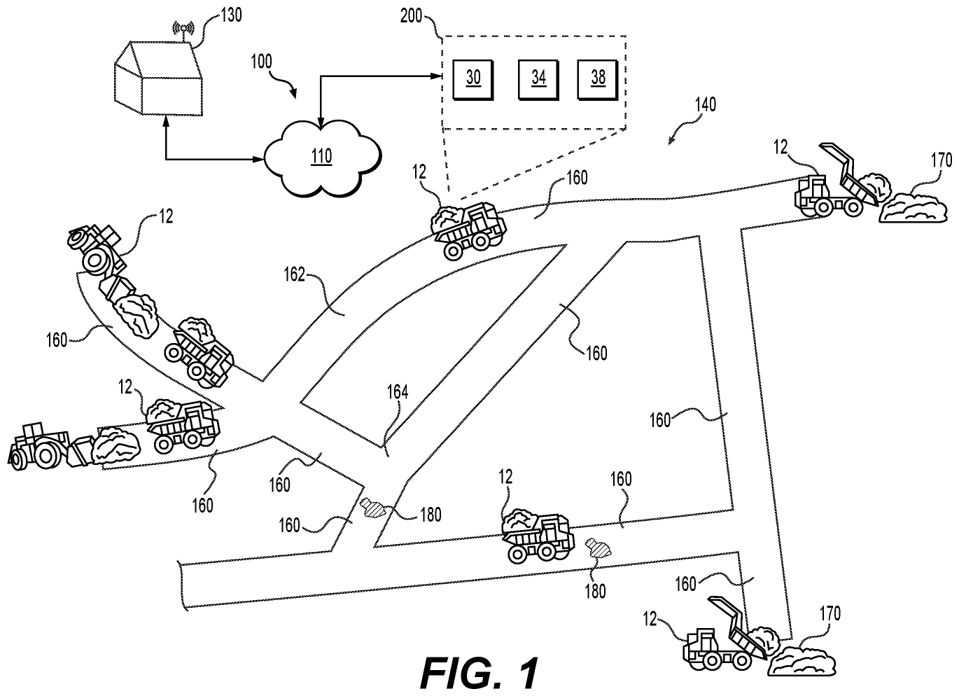

FIG. 1 depicts an exemplary embodiment of an autonomous machine operations system 100, according to techniques presented herein. At least one administrator may interact with a network 110 to communicate with and/or monitor the operation of one or more autonomous (or semi-autonomous) mobile machines 12. The administrator may be located in a back office 130 on-site or off-site from where the machines 12 are being utilized. Some or all or the operations of the machines 12 may occur without operator engagement, and hence the machines 12 may operate autonomously or semi-autonomously. For example, the machines 12 may have onboard software controlling some or all of their operations, and/or the machines 12 may be partially or completely controlled by instructions received from server(s) across the network 110. In particular, machines 12 are programmed to perform one or more operations at a worksite 140, such as a mining site.

Worksite 140 may include a series of paths 160 along which machines 12 travel to perform operations. For example, machines 12 may be programmed to travel along paths 160 to transport material between a load pile 170 and an unload pile 172. Particularly, each machine 12 may be programmed to autonomously collect and/or receive a load of material from load pile 170, travel to unload pile 172 via one or more paths 160, and dump the material into load pile 172.

Paths 160 may include various features such as grade changes (i.e., slopes), curves 162, and intersections 164. Furthermore, obstacles 180 may be located on path(s) 160. Obstacles may include, for example, people, animals, or objects not expected to be on path(s) 160. Further, obstacles 180 may include terrain conditions such as mud or loose soil that affect traction of machines 12.

Machines 12 may be configure to continuously report their location, speed, surroundings, and/or other situational data back to back office 130 via network 110. In particular, each machine includes a control system 200 in communication with back office 130 via network 110. Control system 200 may include or be coupled to a perception device 30, a positioning system 34, and a drive system 38 of machine 12. Perception device 30 may include a camera, laser scanning and/or LiDAR devices, a radar device, etc. mounted to mobile machine 12 and directed outward from mobile machine 12 to generate video of worksite 140, including path(s) 160, any obstacle(s) 180 thereon, and other machine(s) 12 in the vicinity.

Positioning system 34 may include a global positioning system (GPS) for detecting a location, orientation, and/or speed of machine 12 via satellite communication. In some aspects, positioning system 34 may additionally or alternatively include an inertial navigation system (INS) for determining location, orientation, and/or speed using sensors such as one or more accelerometers and/or gyroscopes. Drive system 38 may communicate with and control ground-engaging traction devices (e.g., wheels, tracks) of mobile machine 12. In some aspects, drive system 38 may include an odometer, a wheel speed sensor, a tachometer, or other device configured to determine rotational speed of the traction device.

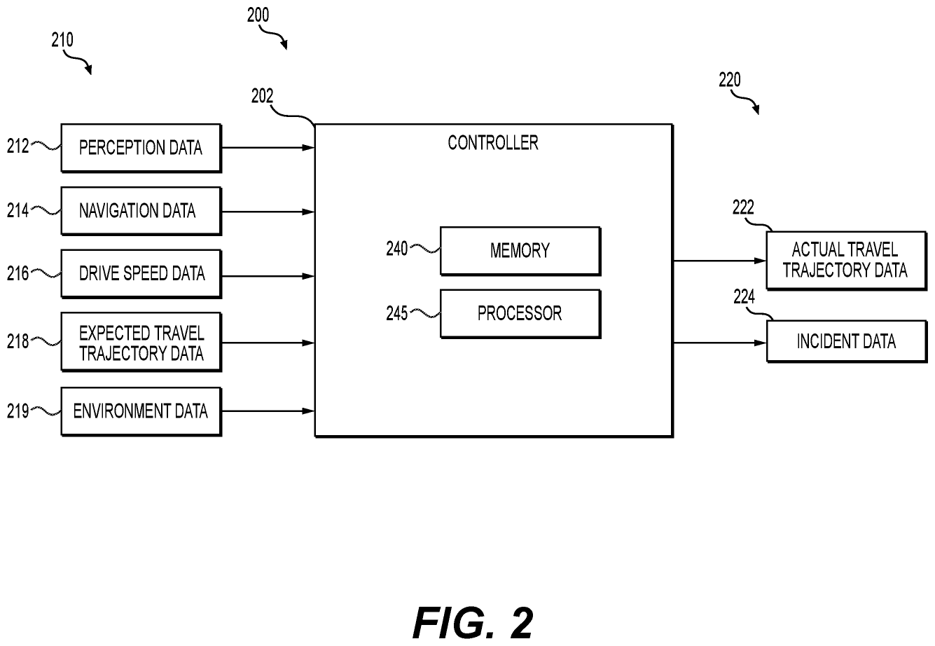

As shown in FIG. 2, a controller 202 of control system 200 is configured for receiving various inputs 210 from various sources, and for providing outputs 220 to back office 130 via network 110. Inputs 210 into controller 202 include perception data 212 received from perception devices 30, navigation data 214 received from positioning system 34, drive speed data 216 received from drive system 38, expected travel trajectory data 218 received from back office 130, and environment data 219 received from back office 130 and or other machines 12 in worksite 140. Perception data 212 may include, for example, one or more videos from perception devices 30 such as video showing paths 160, obstacles 180, and surrounding machines 12. Navigation data 214 may include actual travel trajectory information such as location, orientation, and speed of mobile machine 12. Navigation data 214 may be determined, for example, by positioning system 134 (e.g., GPS and/or INS devices). Drive speed data 216 may include the actual speed and braking characteristic of mobile machine 12, as determined by drive system 38. Expected travel trajectory data 218 may include the expected route and the expected speed at which mobile machine 12 is instructed to travel along one or more path(s) 160 by back office 130. Expected ravel trajectory data 218 may also include planned and/or anticipated delays, e.g. an expected delay while mobile machine 12 is queued at a loading or unloading pile. Environment data 219 may include the locations and travel trajectories of other machines 12 operating at the worksite 140. Particularly, environment data 219 may include the location of machines 12 out of the line of sight of perception device 30 that could not otherwise by known to machine 12. In some aspects, environment data 219 may further include weather data that may affect performance of machine 12.

Control system 200 may provide outputs 220 from controller 202 in the form of actual travel trajectory data 222. Actual travel trajectory data 222 may include the actual route and the actual speed at which mobile machine 12 travels. Outputs 220 may further include incident data 224. Incident data 224 may include information relating to deviations of the actual travel trajectory relative to the expected trajectory. For example, incident data may include occurrences of machine 12 stopping or re-routing to avoid obstacle 180. In some embodiments, actual travel trajectory data 222 and/or incident data 224 may be collected continuously or nearly continuously (e.g., at every 3 meters of machine travel) so that outputs 220 provide a substantially real-time depiction of the operation of mobile machine 12.

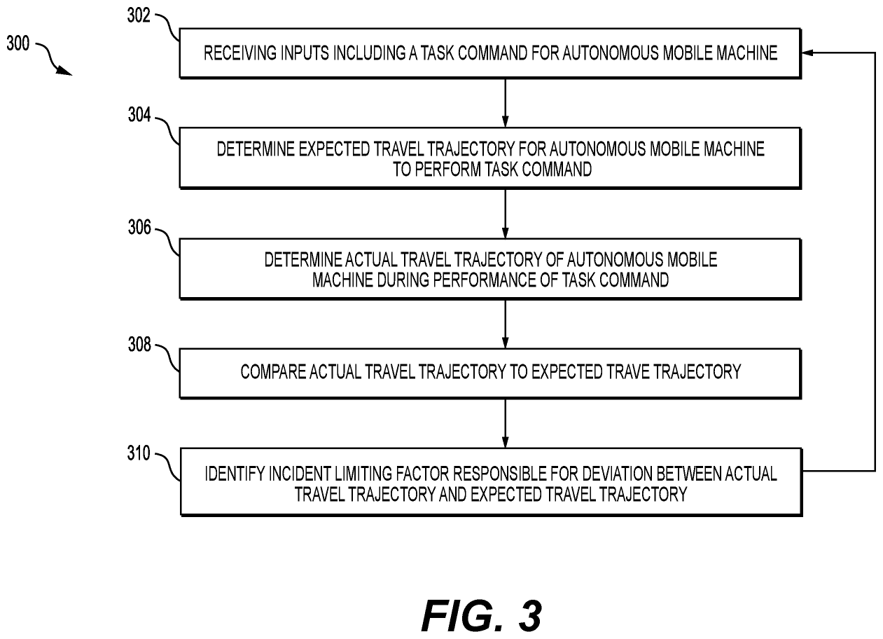

Controller 202 may include memory 240 and one or more processors 245. Memory 240, and/or a secondary storage device associated with controller 202, may store data and/or software instructions that may assist controller 202 in performing various functions, such as the functions of method 300 of FIG. 3. Further, memory 240 and/or secondary storage device associated with controller 202 may also store data received from the various inputs 210. Processor 245 may be configured to execute the software instructions. Numerous commercially available processors can be configured to perform the functions of processor 245. It should be appreciated that controller 202 could readily embody as a general machine controller capable of controlling numerous other machine functions. Alternatively, a special-purpose machine controller could be provided. Various other known circuits may be associated with controller 202, including signal-conditioning circuitry, communication circuitry, hydraulic or other actuation circuitry, and other appropriate circuitry. While control system 200 is illustrated as a component of mobile machine 12, portions of control system 200 may be divided between mobile machine 12 and back office 130. For example, back office 130 may include at least a portion of controller 202.

### Industrial Applicability

System 100 of the present disclosure may be utilized to control, monitor, and/or optimize one or more mobile machines 12 at worksite 140. During operation, each mobile machine 12 autonomously performs one or more cycles including dumping material at unload pile 172, traveling to load pile 170, loading/receiving material at load pile 170, and returning to unload pile 172. The cycle may additionally include queuing time as mobile machine 12 waits for other machines to perform their respective functions at load and unload piles 170, 172.

Throughout performance of the cycle, mobile machine 12 may encounter one or more incident limiting factors such as obstacles 180 in the travel path, weather, other machines 12, and other factors that result in a delay in mobile machine completing the cycle. System 100 of the present disclosure provides for identification of such obstacles and quantification of these obstacles' effects on performance of mobile machine. System 100 may further generate and/or perform virtual simulations to estimate the travel trajectory of mobile machine 12 if such delays did not occur.

FIG. 3 includes a flowchart for an exemplary method 300 for determining optimal machine performance during autonomous operation of mobile machine 12. Method 300 includes, at step 302, receiving inputs including a task command for autonomous mobile machine 12. The task command may correspond to, for example, one or more cycles of dumping material at an unload pile, traveling to a load pile, loading/receiving material at the load pile, and returning to the unload pile. The task command may further include a pre-defined path (e.g., a road or lane) along which mobile machine 12 should travel to perform the task.

Method 300 further includes, at step 304, determining an expected travel trajectory for autonomous mobile machine 12 to perform the task command. The expected travel trajectory may include the ideal or desired time and/or speed at which mobile machine 12 completes the task command. The expected travel trajectory may be based on known parameters of the pre-defined path, such as grade and curvature (e.g., curves 162 of FIG. 1). For example, the grade of the path may have a limiting effect on the travel speed of mobile machine 12, as mobile machine 12 may have to reduce speed in order to avoid overheating the brakes. The load carried by mobile machine 12 may further influence the travel speed, as the load (and consequently heat) on the brakes increases with load carried by mobile machine 12. Thus, mobile machine 12 may be able to travel faster in an unloaded state than in a loaded state. The curvature of the path 160 may also have a limiting effect on the travel speed of mobile machine 12 because mobile machine 12 may be forced to reduce speed to navigate a curve 162. In some aspects, the expected travel trajectory may further account for administrative controls, e.g., limits on travel speed imposed by an administrator of the worksite 140, typically for safety.

Method 300 further includes, at step 306, determining the actual travel trajectory of mobile machine 12 during performance of the task command. The actual travel trajectory corresponds to the actual time and/or speed at which mobile machine 12 completes the task command, inclusive of any external factors not accounted for in the expected travel trajectory determined at step 304. The actual travel trajectory may be determined by speed and/or positioning determining systems onboard mobile machine 12, such as positioning system 34 and drive system 38.

Method 300 further includes, at step 308, comparing the actual travel trajectory to the expected travel trajectory. Step 308 may include, for example, identifying deviations in the actual travel trajectory relative to the expected travel trajectory. In some aspects, the deviation may be a difference in the actual travel speed of mobile machine 12 compared to the expected travel speed of mobile machine. In some aspects, the deviation may be a difference in the actual position or location of mobile machine 12 compared to the expected position or location of mobile machine 12.

Steps, 304 and 306, step 308 may be performed at predetermined intervals, such as a predetermined interval based on distance or time. For example, steps 304, 306, and 308 may be performed once every 3 meters of machine travel. Thus, back office 130 may by continually updated on any difference between the actual and expected travel trajectory through operation of machine 12 (e.g., during a cycle of loading and unloading material).

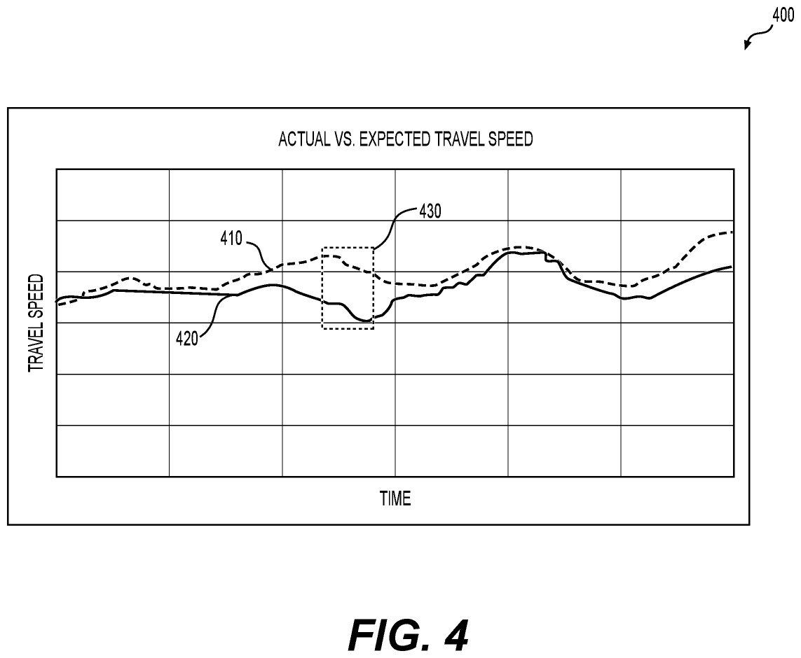

FIG. 4 includes a graph 400 showing a comparison between the actual speed at which mobile machine 12 travels relative to the expected speed at which mobile machine travels. Time (e.g., time within a cycle of operation of mobile machine 12) is shown on the x-axis, and speed of mobile machine 12 is shown on the y-axis. Expected speed is represented by curve 410, and actual speed is represented by curve 420. Curve 420 is composed of a plurality of individual data points (i.e., individual measurements of the speed of mobile machine 12 at predetermined intervals). Where the y-value of curve 420 is less than the contemporaneous y-value of curve 410, mobile machine 12 is travelling at a reduced speed relative to the expected speed. Similarly, where the y-value of curve 420 is greater than the contemporaneous y-value of curve 410, mobile machine 12 is travelling at an increased speed relative to the expected speed. Such deviations between curves 410, 420 indicate occurrence of an incident limiting factor which caused the actual speed of mobile machine 12 to differ from the expected speed of mobile machine 12. For example, window 430 of graph 400 shows a time interval over which the actual speed of mobile machine 12 was less than the expected speed of mobile machine 12. Thus, an incident limiting factor occurred during operation of mobile machine 12 at this time.

While FIG. 4 illustrates differences in the actual and expected travel speed of mobile machine 12, a similar graph could be used to depict differences in actual and expected position of mobile machine.

Method 300 may further include, at step 310, identifying an incident limiting factor responsible for the deviation between the actual travel trajectory and the expected travel trajectory of mobile machine 12. The incident limiting factor may be identified based on onboard systems of mobile machine, such as perception device 30 (see FIG. 1). That is, controller 202 may analyze perception data 212 collected during each interval (e.g., window 430 of FIG. 4) over which the actual travel trajectory deviates from the expected travel trajectory. The perception data 212 may, for example, indicate the presence of an obstacle 180 (e.g., an object, persons, animal, or other machine) in the path 160 of mobile machine. The controller 202 may further determine that mobile machine 12 changed speed in response to the presence of obstacle 180, and thereby identify the obstacle of the incident limiting factor.

In some aspects, information other than perception data 212 may be used to identify the incident limiting factor. For example, slippage of mobile machine 12 may be the incident limiting factor, and may be identified by a combination of navigation data 214 and drive speed data 216 (see FIG. 2). If the position of mobile machine 12 (as determined by navigation data 214) is inconsistent with the speed at which mobile machine 12 is being driven by the wheels or tracks, slippage is present. As another example, environment data 219 (see FIG. 2) relating the positions of other machines may be used to determine that mobile machine 12 had to slow down or change course to avoid another machine, thus resulting in delay.

Steps 302-310 of method 300 may be performed repeatedly during performance of the task command by mobile machine 12. For example, steps 302-310 may be performed at a predetermined unit distance (e.g., every 3 meters) of machine travel during performance of the task command. Thus, identification of incident limiting factors that cause deviations from the expected travel trajectory occurs in real-time or near real-time. As such, cycle data does not need to be post-processed to identify incident limiting factor(s).

Method 300 may further include displaying the incident limiting factor(s) identified at step 310 to an administrator of mobile machine 12. Particularly, the administrator may monitor autonomous operation of mobile machine 12 from back office 130 (see FIG. 1). In some aspects, displaying the incident limiting factors may include displaying a chart (e.g., graph 400 of FIG. 4) showing the actual travel speed of mobile machine 12 relative to the expected speed of mobile machine 12. Further, window 430 of graph 400 may be annotated with the incident limiting factor identified at step 310, so that the administrator can observe the effect of the incident limiting factor on the actual travel speed of mobile machine 12.

In some aspects, method 300 may further include performing simulations of the travel trajectory of mobile machine 12 with the incident limiting factor(s) removed, to determine whether mobile machine 12 could meet the expected travel trajectory if the identified incident limiting factor was not present. Thus, the simulation may provide information as to the feasibility of the expected travel trajectory.

In some aspects, method 300 may further include adjusting the expected travel trajectory based on the incident limiting factors identified at step 310. For example, if the same incident limiting factors repeatedly occur at the same time and/or location of travel of mobile machine 12, the expected travel trajectory may be updated to avoid the incident limiting factor and improve efficiency of operation. In some aspects, the expected travel trajectory may be adjusted so that mobile machine 12 approaches a location of the incident limiting factor at a different time when the incident limit factor is less likely to occur. For example, the expected travel trajectory may be adjusted to so that mobile machine approaches intersection 164 (see FIG. 1) at a time when less other machines are present. As another example, the expected travel trajectory may to adjusted to increase the radius of curve 162 travelled by mobile machine 12 to allow mobile machine 12 to maintain a faster speed through the curve 162. Similarly, the expected travel trajectory may be adjusted to avoid steep grades that require mobile machine 12 to navigate at reduced speed to avoid overheating the brakes.

The systems and methods of the present disclosure may improve the administration of autonomously operated vehicles by identifying specific incident limiting factors that cause deviations from the expected travel trajectory. In particular, the method provides for identifying individual factors that cause a deviation in the actual trajectory of mobile machine 12 relative to the expected travel trajectory. This allows expected travel trajectory to be adjusted, if needed, to optimize the performance of mobile machine 12 and/or a fleet of other machines operating at worksite 140.

It will be apparent to those skilled in the art that various modifications and variations can be made to the disclosed system and method without departing from the scope of the disclosure. Other embodiments of the system and method will be apparent to those skilled in the art from consideration of the specification and system and method disclosed herein. It is intended that the specification and examples be considered as exemplary only, with a true scope of the disclosure being indicated by the following claims and their equivalents.

What is claimed is:

1. A method for managing autonomous vehicle operations, the method comprising:
receiving inputs including a task command for an autonomous mobile machine;
determining an expected travel trajectory for the autonomous mobile machine to perform the task command;
determining an actual travel trajectory of the mobile machine during performance of the task command;
comparing the actual travel trajectory to the expected travel trajectory; and
identifying an incident limiting factor responsible for a deviation between the actual travel trajectory and the expected travel trajectory,
wherein comparing the actual travel trajectory is repeated at predetermined intervals during performance of the task command.

2. The method of claim 1, wherein the predetermined interval comprises a unit distance traveled by the autonomous mobile machine.

3. The method of claim 1, wherein the task command comprises a loading operation, a transport operation, and an unloading operation.

4. The method of claim 1, wherein the incident limiting factor comprises at least one of:
an obstacle in a travel path of the autonomous mobile machine;
a curve in the path of the autonomous mobile machine;
a grade change in the path of the autonomous mobile machine; or
another machine in the path of the autonomous mobile machine.

5. The method of claim 1, wherein the expected travel trajectory comprises at least one of an expected speed or an expected position of the mobile machine.

6. The method of claim 1, wherein the actual travel trajectory comprises at least one of an actual speed or an actual position of the mobile machine.

7. The method of claim 1, further comprising:
displaying the incident limiting factor to an administrator.

8. The method of claim 7, wherein displaying the incident limiting factor comprises displaying a graph of an actual speed of the mobile machine relative to an expected speed of the mobile machine.

9. The method of claim 1, further comprising:
adjusting the expected travel trajectory based on the incident limiting factor.

10. The method of claim 9, wherein adjusting the expected travel trajectory comprises changing a time at which the mobile machine approaches a location associated with the incident limiting factor.

11. A system for managing autonomous vehicle operations, the system comprising:
an autonomous mobile machine configured to perform a task command comprising a loading operation, a transport operation, and an unloading operation
a controller configured to:
determine an actual travel trajectory of the mobile machine during performance of the task command; and
repeatedly at a predetermined unit travel distance of the mobile machine, identify an incident limiting factor responsible for a deviation between the actual travel trajectory and the expected travel trajectory.

12. The system of claim 11, wherein the autonomous mobile machine comprises an onboard system including at least one of a perception device, a positioning system, or a drive system, and
wherein identifying the incident limiting factor is based on input from the onboard system.

13. The system of claim 11, wherein the positioning system comprises at least one of a global positioning system or an inertial navigation system for detecting a location, orientation, or speed of the autonomous mobile machine.

14. The system of claim 11, wherein the incident limiting factor comprises at least one of:
an obstacle in a travel path of the autonomous mobile machine;
a curve in the path of the autonomous mobile machine;
a grade change in the path of the autonomous mobile machine; or
another machine in the path of the autonomous mobile machine.

15. The system of claim 11, wherein identifying and incident limiting factor includes displaying the incident limiting factor as a graph of an actual speed of the mobile machine relative to an expected speed of the mobile machine.

16. A method for managing autonomous vehicle operations, the method comprising:
receiving inputs including a task command for an autonomous mobile machine;
determining an expected travel trajectory for the autonomous mobile machine to perform the task command;
determining an actual travel trajectory of the mobile machine during performance of the task command;
comparing the actual travel trajectory to the expected travel trajectory;
identifying an incident limiting factor responsible for a deviation between the actual travel trajectory and the expected travel trajectory; and
adjusting the expected travel trajectory based on the incident limiting factor.

17. The method of claim 16, wherein the incident limiting factor comprises at least one of:
an obstacle in a travel path of the autonomous mobile machine;
a curve in the path of the autonomous mobile machine;
a grade change in the path of the autonomous mobile machine; or
another machine in the path of the autonomous mobile machine.

18. The method of claim 16, wherein the expected travel trajectory comprises at least one of an expected speed or an expected position of the mobile machine.

19. The method of claim 16, further comprising:
displaying the incident limiting factor to an administrator.

20. The method of claim 16, wherein adjusting the expected travel trajectory comprises changing a time at which the mobile machine approaches a location associated with the incident limiting factor.
